(19) United States
(12) Patent Application Publication
(10) Pub. No.: US 2022/0392275 A1
(43) Pub. Date: Dec. 8, 2022

(54) INFORMATION PROCESSING DEVICE AND DRIVING EVALUATION SYSTEM

(71) Applicants: TOYOTA JIDOSHA KABUSHIKI KAISHA, Toyota-shi (JP); Nomura Research Institute, Ltd., Tokyo (JP)

(72) Inventors: Ryosuke TANIMURA, Nissin-shi (JP); Hiroe Fukui, Toyohashi-shi (JP); Taito Sasaki, Nissin-shi (JP); Katsumi Kanehira, Tokyo (JP)

(73) Assignees: TOYOTA JIDOSHA KABUSHIKI KAISHA, Toyota-shi (JP); Nomura Research Institute, Ltd., Tokyo (JP)

(21) Appl. No.: 17/737,245

(22) Filed: May 5, 2022

(30) Foreign Application Priority Data
Jun. 7, 2021 (JP) 2021-095217

(51) Int. Cl. G07C 5/02; G07C 5/00

(52) U.S. Cl. CPC G07C 5/02; G07C 5/008

(57) ABSTRACT

An information processing device is configured to acquire first data related to a driving operation performed in a first vehicle and second data related to a surrounding condition of the first vehicle, and perform driving evaluation for the first vehicle based on the first data and the second data.

### CROSS-REFERENCE TO RELATED APPLICATION

This application claims priority to Japanese Patent Application No. 2021-095217 filed on Jun. 7, 2021, incorporated herein by reference in its entirety.

### BACKGROUND

### 1. Technical Field

The present disclosure relates to an information processing device and a driving evaluation system.

### 2. Description of Related Art

There is known a system for evaluating driving of a driver. For example, Japanese Unexamined Patent Application Publication No. 2020-177583 (JP 2020-177583 A) discloses a system that collects data related to driving operations at predetermined intervals and diagnoses the degree of dangerous driving based on the collected data.

### SUMMARY

The present disclosure provides an information processing device and a driving evaluation system that improve the validity of driving evaluation.

An information processing device according to a first aspect of the present disclosure includes a controller configured to acquire first data related to a driving operation performed in a first vehicle, acquire second data related to a surrounding condition of the first vehicle, and perform driving evaluation for the first vehicle based on the first data and the second data.

In the information processing device, the second data may be data related to behavior of surrounding traffic for the first vehicle.

In the information processing device, the controller may be configured to perform the driving evaluation based on at least the first data generated in a first period and the second data generated in a second period prior to the first period.

In the information processing device, the controller may be configured to make determination as to whether the driving operation indicated by the first data is caused by the surrounding condition of the first vehicle that is indicated by the second data.

The information processing device may further include a storage configured to store data related to the surrounding condition affecting the driving operation of the first vehicle.

In the information processing device, the controller may be configured to make the determination by using the stored data.

In the information processing device, the controller may be configured to correct evaluation of the driving operation performed in the first vehicle when a causal relationship is found between the surrounding condition and the driving operation.

In the information processing device, the controller may be configured to perform the driving evaluation by using an evaluation model in which the first data and the second data are input data and the driving evaluation is output data, and when a causal relationship is found between the surrounding condition and the driving operation performed in the first vehicle, update the evaluation model to increase a value of the driving evaluation to be output for the input data.

In the information processing device, the first data may include motion data acquired by a sensor mounted on the first vehicle.

In the information processing device, the second data may be image data acquired by a camera mounted on the first vehicle.

In the information processing device, the controller may be configured to make determination about the surrounding condition of the first vehicle based on a result of analyzing the image data.

A driving evaluation system according to a second aspect of the present disclosure includes a first vehicle and an information processing device. The first vehicle includes a first controller configured to acquire first data related to a driving operation performed in the first vehicle, and second data related to a surrounding condition of the first vehicle. The information processing device includes a second controller configured to perform driving evaluation for the first vehicle based on the first data and the second data.

In the driving evaluation system, the second data may be data related to behavior of surrounding traffic for the first vehicle.

In the driving evaluation system, the first controller may be configured to periodically transmit the first data and the second data to the information processing device, and the second controller may be configured to perform the driving evaluation based on at least the first data generated in a first period and the second data generated in a second period prior to the first period.

In the driving evaluation system, the second controller may be configured to make determination as to whether the driving operation indicated by the first data is caused by the surrounding condition of the first vehicle that is indicated by the second data.

In the driving evaluation system, the information processing device may further include a storage configured to store data related to the surrounding condition affecting the driving operation of the first vehicle.

In the driving evaluation system, the second controller may be configured to make the determination by using the stored data.

In the driving evaluation system, the second controller may be configured to correct evaluation of the driving operation performed in the first vehicle when a causal relationship is found between the surrounding condition and the driving operation.

In the driving evaluation system, the first vehicle may further include a sensor configured to acquire motion data as the first data.

In the driving evaluation system, the first vehicle may further include a camera configured to acquire image data as the second data.

Other aspects of the present disclosure relate to a program for causing a computer to execute a method to be executed by the information processing device, or a non-transitory computer-readable storage medium storing the program.

According to the present disclosure, the validity of the driving evaluation can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a driving evaluation system;

FIG. 2 is a diagram illustrating configurations of a center server and an in-vehicle terminal;

FIG. 3 illustrates an example of vehicle data stored in a storage;

FIG. 4 illustrates an example of behavior data stored in the storage;

FIG. 5A illustrates an example of an evaluation model stored in the storage;

FIG. 5B illustrates an example of the evaluation model stored in the storage;

FIG. 6 is a diagram illustrating data to be transmitted and received between modules in a first embodiment;

FIG. 7 is a diagram illustrating a generation timing of data to be processed;

FIG. 8 is a diagram illustrating a process to be executed by a determiner;

FIG. 9 is a flowchart of a process to be executed by a controller in the first embodiment;

FIG. 10 is a flowchart of a process to be executed by the controller in the first embodiment;

FIG. 11 is a diagram illustrating data to be transmitted and received between modules in a second embodiment; and

FIG. 12 is a flowchart of a process to be executed by a controller in the second embodiment.

### DETAILED DESCRIPTION OF EMBODIMENTS

There is a system that evaluates driving of a driver based on a driving operation performed by the driver. In such a system, for example, the evaluation is performed based on the smoothness of the driving operation.

There are cases where operations for avoiding danger occur without the responsibility of the driver. Examples of these cases include a sudden motion of a pedestrian or bicycle into a street, and sudden braking caused by sudden interruption from an adjacent lane. In the related-art driving evaluation system, however, evaluation may be made that the driver has performed an inappropriate driving operation even in these cases.

In an information processing device according to one aspect of the present disclosure, a controller acquires first data related to a driving operation performed in a first vehicle, acquires second data related to a surrounding condition of the first vehicle, and performs driving evaluation for the first vehicle based on the first data and the second data.

The first data is data related to a driving operation performed by a driver. The first data may be data that directly indicates the driving operation or may be data that indirectly indicates the driving operation. For example, the driving operation can indirectly be obtained by sensing the behavior of the first vehicle. Examples of the first data include a steering wheel operation amount, an accelerator or brake operation amount, an acceleration or deceleration of the vehicle, and a yaw rate. The first data can be acquired from the first vehicle, a computer mounted on the first vehicle, or the like.

The second data is data related to the surrounding condition of the first vehicle. Examples of the second data include sensor data obtained by sensing the periphery of the first vehicle, and image data obtained by imaging the periphery of the first vehicle. The surrounding condition may be a traffic condition around the first vehicle. Examples of the traffic condition include positions or motions of another vehicle, a bicycle, and a pedestrian. The surrounding condition may be a condition of an obstacle around the first vehicle, and a driving environment.

By performing the driving evaluation in consideration of the second data in addition to the first data, determination can be made as to, for example, whether the operation performed by the driver is valid (for example, whether the operation is unavoidable). Thus, the accuracy of the driving evaluation can be improved.

The second data may be data related to behavior of surrounding traffic for the first vehicle.

According to such a configuration, determination can be made, for example, that the course of the first vehicle is obstructed and the driving operation is performed to avoid the obstruction.

The controller may perform the driving evaluation based on at least the first data generated in a first period and the second data generated in a second period prior to the first period.

For example, determination can be made as to whether the driving operation indicated by the first data is valid by referring to the second data traced reversely in the period immediately before the driving operation.

The controller may make determination as to whether the driving operation indicated by the first data is caused by the surrounding condition of the first vehicle that is indicated by the second data.

For example, when a specific event indicated by the second data obstructs the course of the first vehicle, determination can be made that the driving operation immediately after the event is caused by the event.

The information processing device may further include a storage configured to store data related to the surrounding condition affecting the driving operation of the first vehicle.

The controller may make the determination by using the stored data.

For example, determination can be made as to whether there is a causal relationship by predefining the surrounding condition affecting the driving operation of the first vehicle, such as a sudden pedestrian's motion into a street or vehicle interruption, and determining the degree of agreement between the caused surrounding condition and the defined surrounding condition.

The controller may correct evaluation of the driving operation performed in the first vehicle when a causal relationship is found between the surrounding condition and the driving operation.

When there is a causal relationship between the surrounding condition and the driving operation, determination can be made that the driving operation is caused by an unavoidable event. Therefore, the evaluation of the driving operation may be corrected in, for example, a positive direction. This makes it possible to compensate for deduction caused by a sudden operation or the like.

The controller may perform the driving evaluation by using an evaluation model in which the first data and the second data are input data and the driving evaluation is output data, and when a causal relationship is found between the surrounding condition and the driving operation performed in the first vehicle, update the evaluation model to increase a value of the driving evaluation to be output for the input data.

The driving evaluation can be performed by using the evaluation model (for example, a machine learning model). In this case, when there is a surrounding condition having a causal relationship with the driving operation, it is preferable to update (retrain) the evaluation model so that the value of the driving evaluation does not decrease under such a condition.

The first data may include motion data acquired by a sensor mounted on the first vehicle.

Examples of the motion data include data related to a motion of the first vehicle. Examples of the motion of the vehicle include an acceleration, a turning rate, and a deceleration.

The second data may be image data acquired by a camera mounted on the first vehicle.

The controller may make determination about the surrounding condition of the first vehicle based on a result of analyzing the image data.

By using the image acquired by the in-vehicle camera, it is possible to make determination about the surrounding condition of the first vehicle.

Hereinafter, specific embodiments of the present disclosure will be described with reference to the drawings. The hardware configuration, module configuration, functional configuration, etc. described in each embodiment are not intended to limit the technical scope of the disclosure to these configurations unless otherwise specified.

### First Embodiment

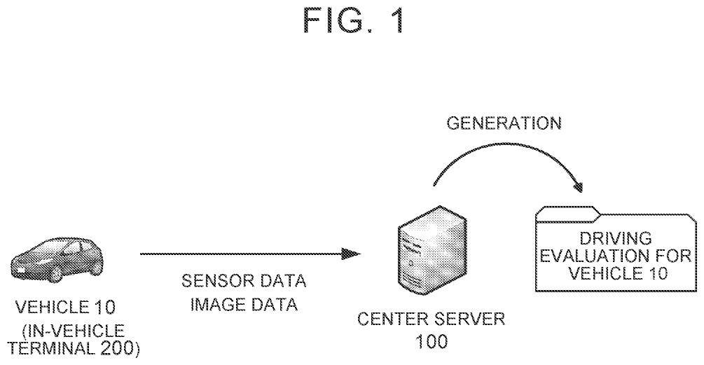

An outline of a driving evaluation system according to a first embodiment will be described with reference to FIG. 1. The driving evaluation system according to the present embodiment includes a center server 100 that evaluates driving of a driver, and an in-vehicle terminal 200 mounted on a vehicle 10.

Although one vehicle 10 is illustrated in FIG. 1, a plurality of vehicles 10 may be managed by the center server 100.

The in-vehicle terminal 200 is a computer mounted on each of the vehicles 10 under the management. The in-vehicle terminal 200 acquires vehicle data and periodically transmits the vehicle data to the center server 100. The vehicle data includes two types of data that are “data related to a driving operation performed by the driver (first data)” and “data related to surrounding conditions of the vehicle 10 (second data)”.

The center server 100 acquires pieces of vehicle data from the vehicles 10 (in-vehicle terminals 200) under the management of the system, and evaluates the driving operations performed by the drivers based on the pieces of vehicle data (for example, evaluates how smoothly the driving operations are performed).

The center server 100 determines what kind of situation occurs around the vehicle 10 based on the second data indicating the surrounding conditions of the vehicle 10, and then evaluates the first data. As a result, even when a sudden operation is performed due to an unavoidable event, this sudden operation can be evaluated validly.

In the present embodiment, the first data is sensor data indicating a driving operation performed in the vehicle 10. The first data can be acquired by a sensor in the vehicle 10.

In the present embodiment, the second data is image data to be used for analyzing the behavior of surrounding traffic for the vehicle 10. The surrounding traffic refers to a moving body located near the vehicle 10, such as another vehicle, a bicycle, or a pedestrian. The image data can be acquired by, for example, a camera mounted at the front of the vehicle 10.

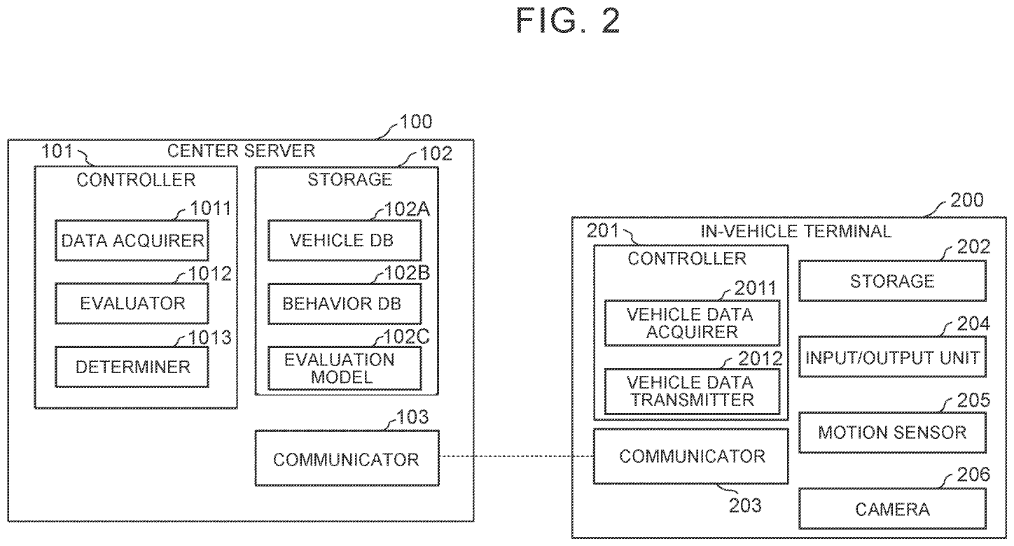

FIG. 2 is a diagram illustrating components of the driving evaluation system according to the present embodiment in more detail.

The in-vehicle terminal 200 is a computer mounted on the vehicle. The in-vehicle terminal 200 includes a controller 201, a storage 202, a communicator 203, an input/output unit 204, a motion sensor 205, and a camera 206.

The controller 201 is an arithmetic unit responsible for control that is performed by the in-vehicle terminal 200. The controller 201 can be implemented by an arithmetic processing unit such as a central processing unit (CPU).

The controller 201 includes two functional modules that are a vehicle data acquirer 2011 and a vehicle data transmitter 2012. These functional modules may be implemented by the CPU executing programs stored in the storage 202 that will be described later.

The vehicle data acquirer 2011 acquires vehicle data. In the present embodiment, the vehicle data includes the following two types of data.

(1) Data related to a driving operation performed by the driver (sensor data)

(2) Image data acquired by the in-vehicle camera

The sensor data corresponds to the first data, and the image data corresponds to the second data.

The data related to the driving operation is data indicating the behavior of the vehicle (motion data), and is typically data indicating an acceleration acquired by the motion sensor 205 described later. In this example, the acceleration measured by the sensor is exemplified as the sensor data, but the sensor data may include other information as long as the sensor data is related to the driving operation. For example, the sensor data may include a speed and a yaw rate. The sensor data is not limited to the one obtained by sensing the motion of the vehicle. For example, the sensor data may be data indicating the driving operation and acquired from a steering sensor or a throttle sensor.

The vehicle data acquirer 2011 acquires the sensor data at a predetermined sampling rate (for example, 10 Hz). The sensor data may be acquired at a sampling rate higher than the target sampling rate and then smoothed by a filter. For example, the data may be sampled at 100 Hz and then downsampled to 10 Hz by using a Gaussian filter or the like.

The image data is acquired by the camera 206 described later. The “image data” described herein may be data for one frame or data for a plurality of frames. The vehicle data acquirer 2011 may acquire data other than the sensor data and the image data and include the data in the vehicle data. Examples of such data include position information, a speed, and a traveling direction of the vehicle 10.

The vehicle data transmitter 2012 periodically (for example, at an interval of one second) transmits the vehicle data acquired by the vehicle data acquirer 2011 to the center server 100.

When the transmission interval of the vehicle data is one second, the vehicle data can include, for example, sensor data for one second and image data for one second. The image data may be a set of a plurality of images. For example, when the transmission interval of the vehicle data is one second and the vehicle data acquirer 2011 can acquire images in 30 frames per second, the vehicle data transmitted at one time may include image data including 30 images. When the vehicle data acquirer 2011 can acquire the sensor data at 10 Hz, one piece of vehicle data may include sensor data for 10 time steps.

The storage 202 includes a main storage device and an auxiliary storage device. The main storage device is a memory where a program to be executed by the controller 201 and data to be used by the control program are loaded. The auxiliary storage device stores programs to be executed by the controller 201 and data to be used by the control programs. The auxiliary storage device may store a package of applications of the programs to be executed by the controller 201. The auxiliary storage device may store an operating system for running these applications. The programs stored in the auxiliary storage device are loaded into the main storage device and executed by the controller 201. Processes that will be described later are thus performed.

The main storage device may include a random access memory (RAM) or a read only memory (ROM). The auxiliary storage device may include an erasable programmable ROM (EPROM) or a hard disk drive (HDD). The auxiliary storage device may include a removable medium, that is, a portable recording medium.

The communicator 203 is a wireless communication interface for connecting the in-vehicle terminal 200 to a network. The communicator 203 is communicable with the center server 100 via, for example, a wireless local area network (LAN) or a mobile communication service such as third generation (3G), Long-Term Evolution (LTE), or fifth generation (5G).

The input/output unit 204 receives an input operation performed by a user and presents information to the user. In the present embodiment, the input/output unit 204 is a single touch panel display. That is, the input/output unit 204 includes a liquid crystal display and its controller, and a touch panel and its controller.

The motion sensor 205 measures an acceleration applied to the vehicle 10. Examples of the motion sensor 205 include a three-axis acceleration sensor capable of measuring accelerations applied in a fore-and-aft direction, a lateral direction, and a vertical direction of the vehicle. In this case, the sensor data can be a three-dimensional vector. The camera 206 captures an image of a view around the vehicle 10. The camera 206 is preferably mounted at least in a position where the camera 206 can capture an image of a view ahead of the vehicle 10.

Next, the center server 100 will be described.

The center server 100 executes a process for receiving vehicle data from the in-vehicle terminal 200 and a process for evaluating a driving operation performed by the driver of the vehicle 10 based on the received vehicle data.

The center server 100 may be a general-purpose computer. That is, the center server 100 may be a computer including a processor such as a CPU or a graphics processing unit (GPU), a main storage device such as a RAM or a ROM, and an auxiliary storage device such as an EPROM, a hard disk drive, or a removable medium. An operating system (OS), various programs, various tables, and the like are stored in the auxiliary storage device. The programs stored in the auxiliary storage device are executed by being loaded into a work area of the main storage device. Through the execution of the programs, the individual components are controlled to implement various functions for predetermined purposes as described later. Part or all of the functions may be implemented by a hardware circuit such as an application-specific integrated circuit (ASIC) or a field-programmable gate array (FPGA).

A controller 101 is an arithmetic unit responsible for control that is performed by the center server 100. The controller 101 can be implemented by an arithmetic processing unit such as a CPU.

The controller 101 includes three functional modules that are a data acquirer 1011, an evaluator 1012, and a determiner 1013. Each functional module may be implemented by the CPU executing the stored programs.

The data acquirer 1011 executes a process for acquiring vehicle data from the in-vehicle terminal 200 mounted on the vehicle under the management of the system and storing the acquired vehicle data in a storage 102 that will be described later.

The evaluator 1012 evaluates a driving operation performed by the driver of the vehicle 10 based on the stored vehicle data, and generates data indicating an evaluation result (evaluation data).

For example, the evaluator 1012 evaluates sensor data by a predetermined evaluation model, and acquires a numerical value that evaluates the smoothness of the driving operation. The evaluator 1012 requests the determiner 1013 described later to determine whether the driving operation indicated by the sensor data is caused by the behavior of surrounding traffic. The evaluator 1012 generates final evaluation data in consideration of a result of the determination made by the determiner 1013.

For example, when determination is made that a specific driving operation is caused by the behavior of the surrounding traffic as in a case where a pedestrian is observed to jump into a street immediately before sudden braking, the evaluator 1012 takes action not to deduct a score for the sudden braking operation. A specific method will be described later.

Based on a request from the evaluator 1012, the determiner 1013 determines whether there is a causal relationship between the driving operation and the behavior of the surrounding traffic. Specifically, the determiner 1013 refers to image data acquired immediately before the driving operation to be evaluated, and determines whether the behavior of surrounding traffic obtained by analyzing the image data agrees with a predetermined behavior pattern.

The predetermined behavior pattern is a behavior pattern of surrounding traffic (for example, a sudden stop of a preceding vehicle or a sudden pedestrian's motion into a street) that is likely to be linked to a specific driving operation (for example, sudden braking). When the behavior of the surrounding traffic agrees with the predetermined behavior pattern, determination can be made that there is a causal relationship between the driving operation and the behavior of the surrounding traffic.

The storage 102 includes a main storage device and an auxiliary storage device. The main storage device is a memory where a program to be executed by the controller 101 and data to be used by the control program are loaded. The auxiliary storage device stores programs to be executed by the controller 101 and data to be used by the control programs.

The storage 102 stores a vehicle database 102A, a behavior database 102B, and an evaluation model 102C.

The vehicle database 102A is a database that stores vehicle data acquired from the in-vehicle terminal 200. The vehicle database 102A stores a plurality of pieces of vehicle data acquired from a plurality of in-vehicle terminals 200.

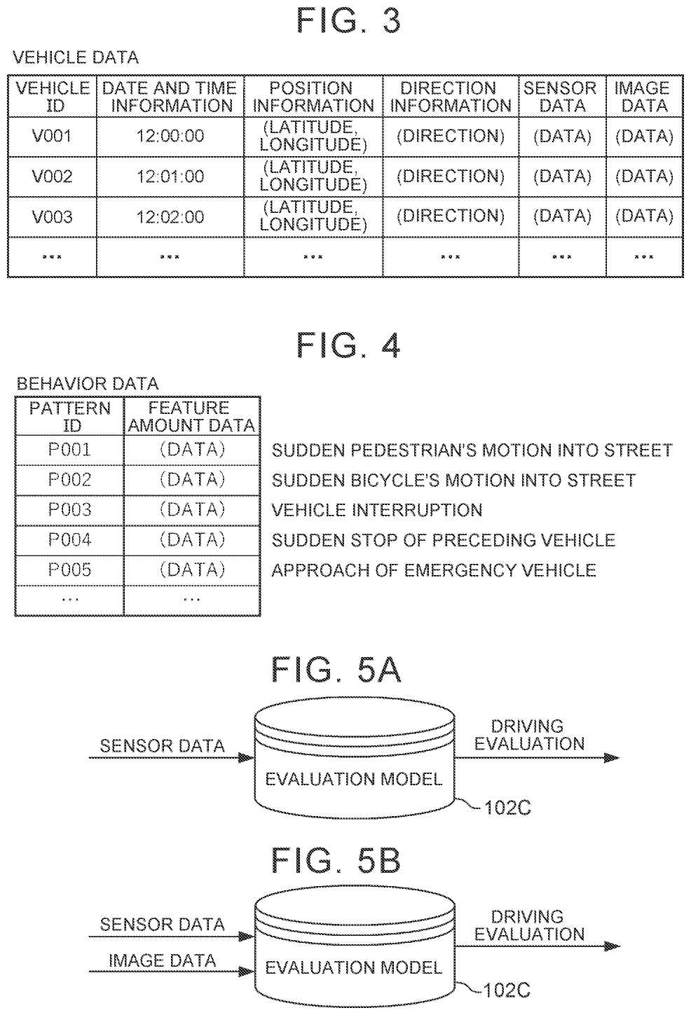

FIG. 3 is a diagram illustrating an example of the data stored in the vehicle database 102A. An identifier (ID) that uniquely identifies the vehicle is stored in a vehicle ID field. Date and time when the vehicle data is generated are stored in a date and time information field. Position information of the vehicle is stored in a position information field. For example, the position information may be represented by latitude and longitude. Information indicating a traveling direction of the vehicle is stored in a direction information field.

Sensor data acquired by the motion sensor 205 of the vehicle 10 is stored in a sensor data field. Image data acquired by the camera 206 of the vehicle 10 is stored in an image data field. The image data may be moving image data composed of a plurality of frames.

The vehicle database 102A is periodically updated based on the vehicle data transmitted from the in-vehicle terminal 200.

The behavior database 102B is a database that stores behavior patterns of surrounding traffic (for example, a sudden pedestrian's motion into a street) that are likely to be linked to a specific driving operation (for example, sudden braking). The behavior pattern stored in the behavior database 102B is a pattern corresponding to an external situation that is assumed to be unpredictable by the driver.

FIG. 4 is a diagram illustrating an example of the data stored in the behavior database 102B. Data that uniquely identifies the behavior pattern is stored in a pattern ID field. Data obtained by converting the behavior of surrounding traffic into a feature amount is stored in a feature amount data field. When a feature amount obtained by converting image data obtained by the in-vehicle camera shows a high degree of similarity to these pieces of data, there is a strong possibility that a specific driving operation is performed due to the behavior of the surrounding traffic. That is, it is presumed that there is a causal relationship between the driving operation performed by the driver and the behavior of the surrounding traffic.

The vehicle database 102A and the behavior database 102B are constructed such that a program of a database management system (DBMS) executed by the processor manages the data stored in the storage device. The vehicle database 102A and the behavior database 102B are, for example, relational databases.

The evaluation model 102C is a machine learning model for evaluating a driving operation performed by the driver. FIG. 5A is a diagram illustrating input data and output data for the evaluation model 102C. As illustrated in FIG. 5A, the evaluation model 102C acquires sensor data as input data and generates driving evaluation as output data. The driving evaluation is represented by, for example, a score. The evaluation model 102C is, for example, trained to output a higher score as the driving operation is smoother.

In this example, only the sensor data is exemplified as the input to the evaluation model 102C, but other information may be given as the input data. For example, it is possible to determine with higher accuracy whether the driving operation performed by the driver is appropriate by giving information related to a road where the vehicle 10 is traveling (for example, number of lanes, speed limit, curvature, and presence or absence of a crosswalk and a traffic light).

Therefore, the center server 100 may store map data or the like including detailed information on roads where the vehicle 10 can travel.

A communicator 103 is a communication interface for connecting the center server 100 to the network. The communicator 103 includes, for example, a network interface board and a wireless communication module for wireless communication.

The configurations illustrated in FIG. 2 are examples, and all or part of the functions illustrated in FIG. 2 may be performed by using circuits designed exclusively for those functions. The programs may be stored in or executed by a combination of a main storage device and an auxiliary storage device other than the combinations illustrated in FIG. 2.

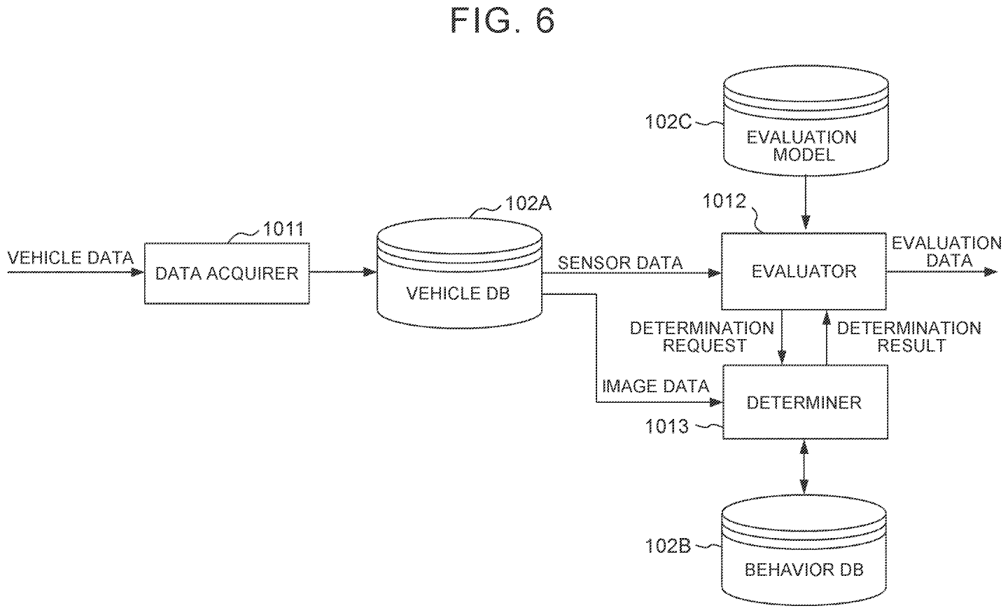

FIG. 6 is a diagram illustrating operations of the modules in the controller 101.

The data acquirer 1011 periodically receives vehicle data from the vehicle 10 (in-vehicle terminal 200) under the management. The received vehicle data is stored in the vehicle database 102A at any time.

The evaluator 1012 acquires sensor data corresponding to an evaluation target period from the pieces of data stored in the vehicle database 102A, and performs driving evaluation. Since the recorded sensor data is an instantaneous value, determination as to what kind of driving operation has been performed cannot be made based on a single piece of sensor data. Therefore, the evaluator 1012 performs the driving evaluation based on a set of sensor data in a predetermined period (for example, one second).

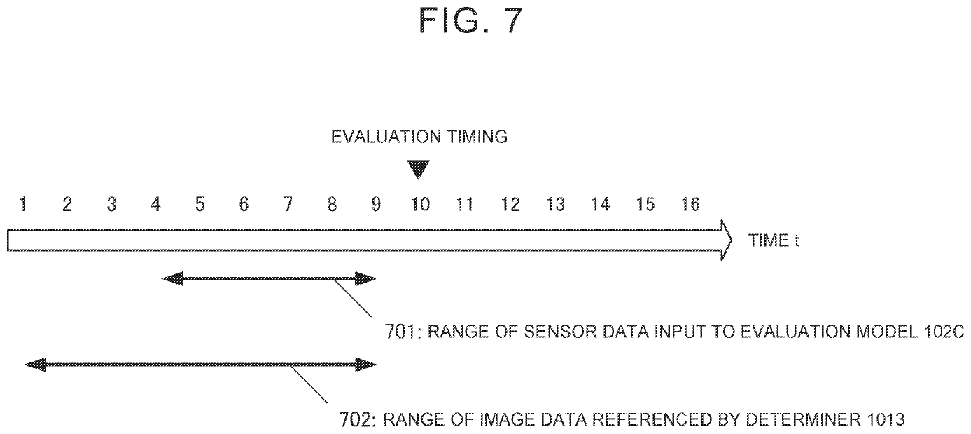

FIG. 7 is a diagram illustrating a relationship between the predetermined period and a timing to perform the driving evaluation. In this example, the evaluator 1012 inputs, into the evaluation model 102C, time-series sensor data traced reversely by predetermined steps (for example, five steps) from an evaluation timing, and acquires a value output from the evaluation model 102C. In the illustrated example, time-series sensor data corresponding to a period indicated by reference numeral 701 is input to the evaluation model 102C.

The evaluator 1012 gives a determination request to the determiner 1013 to check whether the evaluation result obtained by the evaluation model 102C is valid. For example, when a pedestrian jumps into a street at a timing of t=3, a sudden brake is applied at a timing of t=5, and then the driving evaluation is performed, determination can be made that the driving operation is caused by an unavoidable event by checking image data traced reversely in time. In this way, the evaluator 1012 requests the determiner 1013 to check the image data traced reversely in time at the timing to perform the driving evaluation. In the example illustrated in FIG. 7, the determiner 1013 makes determination by referring to image data corresponding to a period indicated by reference numeral 702.

In response to the determination request, the determiner 1013 refers to the image data acquired in the past, and determines whether the behavior of surrounding traffic obtained by analysis agrees with a predetermined behavior pattern stored in the behavior database 102B. The determination may be made based on the degree of similarity. When the behavior of the surrounding traffic agrees with the predetermined behavior pattern stored in the behavior database 102B, the determiner 1013 returns, to the evaluator 1012, a determination result showing “detection of the behavior of the surrounding traffic presumed to have a causal relationship with the most recent driving operation”.

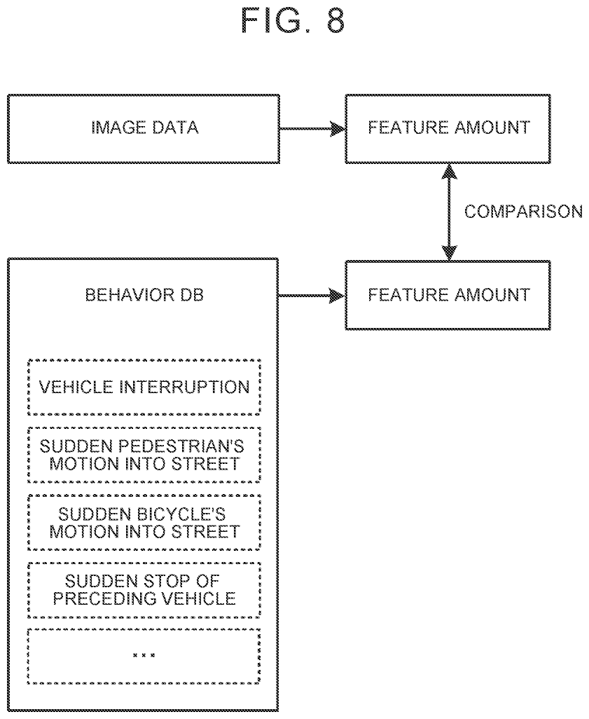

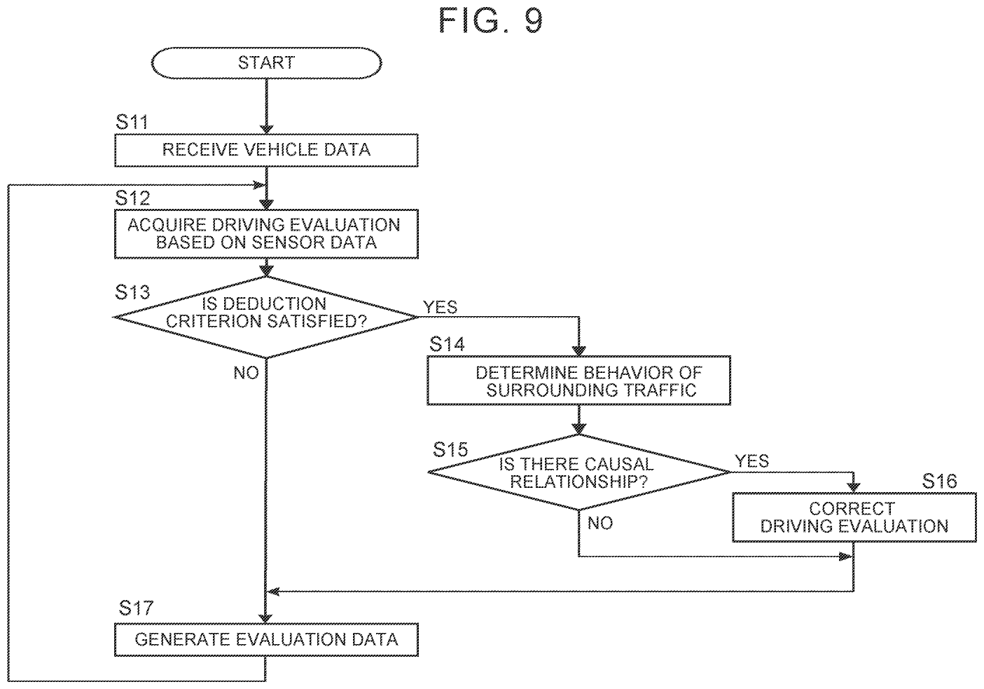

FIG. 8 is a diagram illustrating a determination process to be executed by the determiner 1013. The determiner 1013 determines a period corresponding to a request from the evaluator 1012, acquires image data in this period, and then converts the image data into a feature amount. The period can be determined in advance. The starting point of the period is preferably a time (t=1 in the example of FIG. 7) before the starting point of the sensor data to be evaluated (t=4 in the example of FIG. 7). The determiner 1013 acquires a feature amount corresponding to each behavior pattern from the behavior database 102B and compares the feature amounts. Based on this result, determination can be made as to whether the behavior of the surrounding traffic corresponds to any of the predefined behavior patterns. When determination is made that both the feature amounts agree with each other as a result of comparing the feature amounts, determination can be made that there is a causal relationship between the driving operation performed by the driver and the behavior of the surrounding traffic observed most recently.

The evaluator 1012 adds details of the determination made by the determiner 1013 to the driving evaluation generated by the evaluation model 102C, thereby generating evaluation data. For example, when sudden braking occurs on a road without a traffic light or a crosswalk, evaluation data indicating a low evaluation score is generated in principle. When the determiner 1013 determines that the sudden braking is caused by the behavior of the surrounding traffic (for example, a sudden pedestrian's motion into a street), it is inappropriate to give the low evaluation score. In such a case, the evaluator 1012 revises the evaluation criterion or corrects the evaluation result to improve the evaluation for the driving operation.

The amount for correcting the driving evaluation may be determined based on the type of behavior pattern. For example, the amount of brake operation may differ between the interruption by another vehicle and the sudden pedestrian's motion into a street. For example, when the behavior pattern is “sudden pedestrian's motion into street”, the correction amount may be larger than that in a case where the behavior pattern is “interruption by other vehicle”. The correction amount may be stored in the behavior database 102B in association with the behavior pattern.

Even if there is a causal relationship between the driving operation performed by the driver and the behavior of the surrounding traffic, the driving evaluation should not be corrected depending on conditions. Examples of such a case include a case where a pedestrian is crossing over a crosswalk, a case where the vehicle 10 is facing a red light signal, and a case where the vehicle 10 encounters another vehicle traveling on a priority road. When the driver of the vehicle 10 is negligent, the driving evaluation should not be corrected. Therefore, the evaluator 1012 may further acquire other data related to surrounding conditions of the vehicle 10 (other than the behavior of the surrounding traffic) and further determine whether the driver is negligent based on the data. Examples of the other data related to the surrounding conditions of the vehicle 10 include a location where a traffic light is installed, a location where a crosswalk is provided, a location where a stop sign is provided, and map data describing a priority relationship between roads. When determination is made that the vehicle 10 is negligent as a result of referring to such data, the evaluator 1012 need not correct the driving evaluation regardless of the behavior of the surrounding traffic.

Next, a flowchart of a process to be executed by each module of the controller 101 will be described. The process in the flowchart illustrated in FIG. 9 is periodically executed for each of the vehicles 10 while the system is in operation.

In Step S11, the data acquirer 1011 receives vehicle data transmitted from the in-vehicle terminal 200. The received vehicle data is stored in the vehicle database 102A.

In Step S12, the evaluator 1012 generates evaluation data based on the acquired sensor data. For example, as illustrated in FIG. 7, time-series sensor data traced reversely by a predetermined period from an evaluation timing is given to the evaluation model 102C as input data, and output driving evaluation is acquired.

In Step S13, determination is made as to whether the generated driving evaluation satisfies a predetermined deduction criterion. For example, when driving evaluation having a score lower than a predetermined threshold is generated in Step S12, a positive determination is made in Step S13.

When the positive determination is made in Step S13, the process proceeds to Step S14, and the determiner 1013 determines the behavior of surrounding traffic. That is, determination is made as to whether the driving operation that has caused the deduction is ascribed to the behavior of the surrounding traffic.

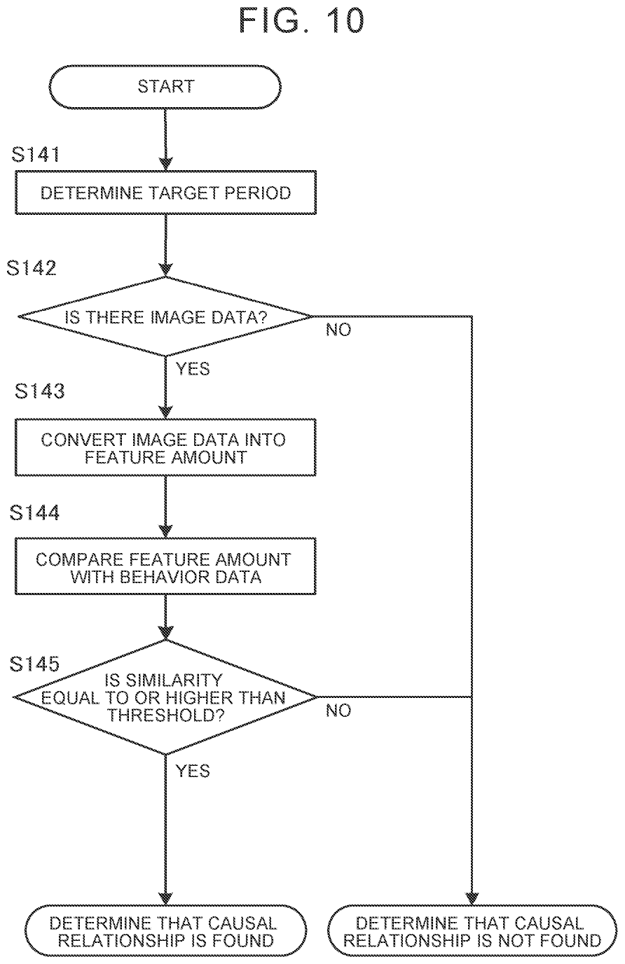

FIG. 10 is a flowchart of a process to be executed by the determiner 1013 in Step S14.

In Step S141, a reference period of image data for the determination is first determined. The reference period of the image data preferably starts from a time before the starting point of the time-series sensor data to be evaluated. For example, when the driving evaluation is performed at a timing of t=10 as illustrated in FIG. 7, a predetermined period (reference numeral 702) traced reversely from this timing is determined. In this example, a period corresponding to t=1 to 9 is determined.

In Step S142, determination is made as to whether image data corresponding to the determined period is stored in the vehicle database 102A. When a negative determination is made, the process is terminated. When a positive determination is made, the process proceeds to Step S143. In Step S143, the image data corresponding to the determined period is acquired and converted into a feature amount. In Step S144, as illustrated in FIG. 8, the feature amount obtained by the conversion is compared with the feature amount corresponding to each of a plurality of behavior patterns stored in the behavior database 102B to obtain similarity.

In Step S145, determination is made as to whether any behavior pattern has similarity exceeding a predetermined value. When a positive determination is made, the determiner 1013 generates a determination result showing “detection of the behavior of the surrounding traffic presumed to have a causal relationship with the driving operation”. When a negative determination is made in Steps S142 and S145, the determiner 1013 generates a determination result showing that “the behavior of the surrounding traffic presumed to have a causal relationship with the driving operation is not detected”.

Returning to FIG. 9, the description will be continued. When the causal relationship is found between the driving operation and the behavior of the surrounding traffic as a result of the determination made in Step S14 (Step S15: Yes), the process proceeds to Step S16 and the driving evaluation generated in Step S12 is corrected. For example, when the driving evaluation shows a low score, the range of deduction is reduced or the deduction is withdrawn. When no causal relationship is found between the driving operation and the behavior of the surrounding traffic (Step S15: No), the process is terminated. As described above, the correction amount of the driving evaluation may differ depending on the behavior pattern. The evaluator 1012 may determine the negligence of the driver of the vehicle 10 by referring to other data related to the driving environment of the vehicle 10, and need not correct the driving evaluation when determination is made that there is a negligence.

In Step S17, the evaluator 1012 generates evaluation data based on the driving evaluation acquired in Step S12 or corrected in Step S16. The evaluation data may be stored in the storage 102 or transmitted to an external device (for example, a device managed by an operation manager of the vehicle 10).

As described above, in the driving evaluation system according to the first embodiment, when a low evaluation score is given for a driving operation, image data obtained by the in-vehicle camera immediately before the driving operation is acquired, and a causal relationship between the behavior of surrounding traffic and the driving operation is estimated. When the causal relationship is found, the driving evaluation is corrected. This makes it possible to perform valid driving evaluation even when a sudden operation occurs due to an unavoidable event.

### Second Embodiment

In the first embodiment, the evaluator 1012 generates the driving evaluation based only on the sensor data. In a second embodiment, the evaluator 1012 generates the driving evaluation based on both the sensor data and the image data.

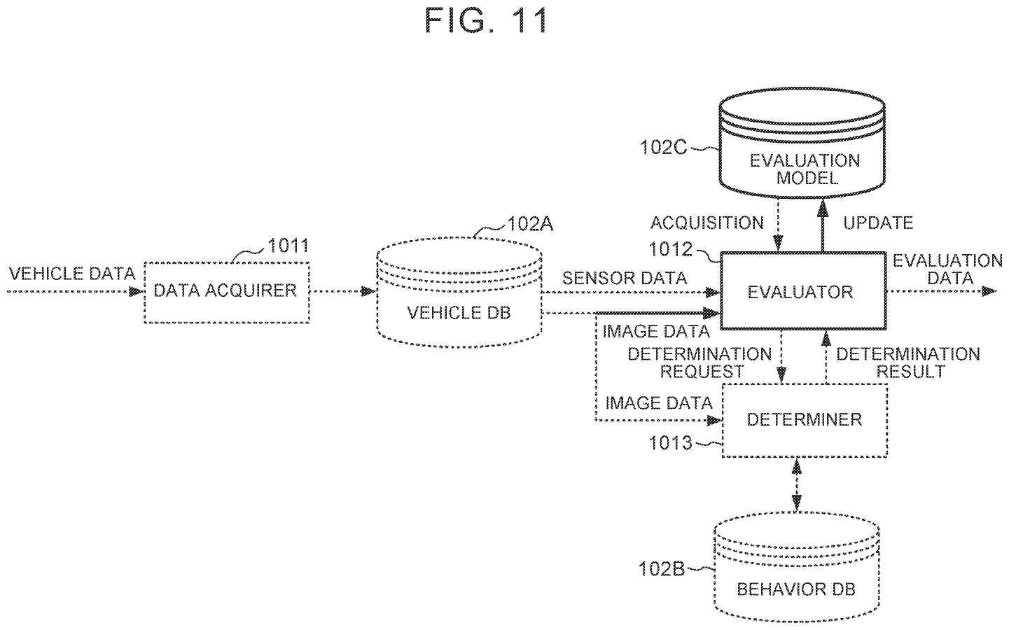

FIG. 11 is a diagram illustrating operations of the modules in the controller 101 in the second embodiment. The same parts as those of the first embodiment are represented by dashed lines, and their description will be omitted. In the second embodiment, the evaluator 1012 acquires both the sensor data and the image data, inputs these pieces of data into the evaluation model 102C, and acquires driving evaluation. FIG. 5B is a diagram illustrating input and output for the evaluation model 102C in the second embodiment.

In the second embodiment, the evaluator 1012 acquires time-series sensor data traced reversely by predetermined steps from an evaluation timing and inputs the time-series sensor data to the evaluation model 102C as in the first embodiment. The evaluator 1012 acquires time-series image data traced reversely by a longer period than that of the sensor data and inputs the time-series image data to the evaluation model 102C. These periods may be the same as those described with reference to FIG. 7. This makes it possible to generate the driving evaluation based on both the sensor data corresponding to the driving operation and the image data showing the behavior of the surrounding traffic affecting the driving operation.

In the second embodiment, when the evaluator 1012 corrects the driving evaluation, the evaluation model 102C is retrained based on details of the correction. That is, when a predetermined behavior pattern is detected from the surrounding traffic and the driving evaluation is corrected, the algorithm of the evaluation model 102C is reconstructed so that the evaluation score does not decrease when a similar scene occurs in the future. This makes it possible to obtain an evaluation model that can make more valid driving evaluation.

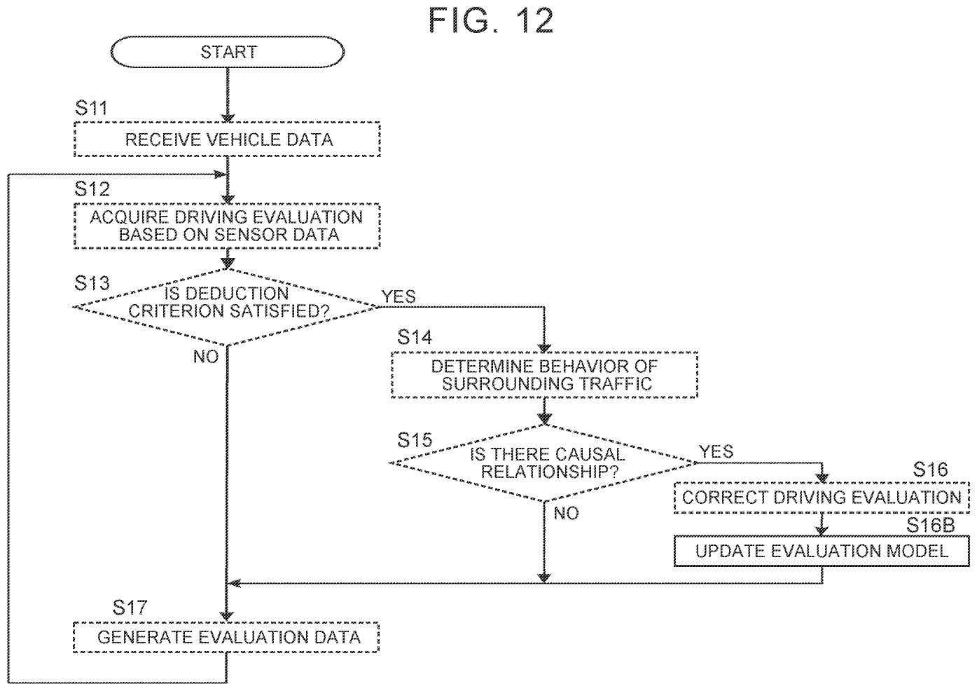

FIG. 12 is a flowchart of a process to be executed by each module of the controller 101 in the second embodiment. The same processes as those of the first embodiment are represented by dashed lines, and their description will be omitted. In the second embodiment, the evaluator 1012 executes a process of Step S16B after the driving evaluation is corrected in Step S16. In Step S16B, the evaluator 1012 updates the evaluation model 102C. Specifically, the algorithm is retrained so as not to deduct the score for the input data (combination of sensor data and image data) that is the premise of the driving evaluation.

According to the second embodiment, the evaluation model can learn the scene in which the driving operation is caused by an unavoidable event. Thus, it is possible to obtain a more accurate evaluation model.

### MODIFICATIONS

The embodiments described above are only illustrative, and the present disclosure may be modified as appropriate without departing from the gist of the present disclosure. For example, the processes and means described in the present disclosure may be combined as desired as long as no technical contradiction occurs.

In the description of the embodiments, the image data is exemplified as the second data, but the second data is not limited to the image data. For example, the second data may be a distance map acquired by a distance sensor, or may be sensor data acquired by another sensor. In the description of the embodiments, the data indicating the behavior of the surrounding traffic is exemplified as the second data, but the second data is not limited to the data indicating the behavior of the surrounding traffic as long as the data indicates the surrounding conditions of the vehicle 10. For example, the second data may be data that can provide determination that the driving environment has deteriorated abruptly, or may be data indicating approach of an obstacle such as a falling object or a rockfall.

In the description of the embodiments, the image data serving as the second data is acquired by the in-vehicle camera, but may be obtained by a device other than the vehicle 10. For example, the image data may be obtained by another vehicle located near the vehicle 10 or by a roadside device. In the description of the embodiments, the feature amount is stored in the behavior database 102B, but a plurality of pieces of image data corresponding to a plurality of behavior patterns may be stored in the database and the behavior pattern may be determined by determining a similarity between pieces of image data each time.

The process described as being executed by a single device may be executed by a plurality of devices in cooperation. Alternatively, the process described as being executed by different devices may be executed by a single device. In the computer system, the hardware configuration (server configuration) that implements functions may be changed flexibly.

The present disclosure may be embodied such that a computer program that implements the functions described in the embodiments described above is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any types of disk or disc such as magnetic disks (for example, a floppy (registered trademark) disk and a hard disk drive (HDD)) and optical discs (for example, a compact disc ROM (CD-ROM), a digital versatile disc (DVD), and a Blu-ray disc), and any types of medium suitable to store electronic instructions, such as a read only memory (ROM), a random access memory (RAM), an EPROM, an electrically erasable programmable ROM (EEPROM), a magnetic card, a flash memory, and an optical card.

What is claimed is:

1. An information processing device comprising a controller configured to:
acquire first data related to a driving operation performed in a first vehicle;
acquire second data related to a surrounding condition of the first vehicle; and
perform driving evaluation for the first vehicle based on the first data and the second data.

2. The information processing device according to claim 1, wherein the second data is data related to behavior of surrounding traffic for the first vehicle.

3. The information processing device according to claim 1, wherein the controller is configured to perform the driving evaluation based on at least the first data generated in a first period and the second data generated in a second period prior to the first period.

4. The information processing device according to claim 1, wherein the controller is configured to make determination as to whether the driving operation indicated by the first data is caused by the surrounding condition of the first vehicle that is indicated by the second data.

5. The information processing device according to claim 4, further comprising a storage configured to store data related to the surrounding condition affecting the driving operation of the first vehicle.

6. The information processing device according to claim 5, wherein the controller is configured to make the determination by using the stored data.

7. The information processing device according to claim 4, wherein the controller is configured to correct evaluation of the driving operation performed in the first vehicle when a causal relationship is found between the surrounding condition and the driving operation.

8. The information processing device according to claim 4, wherein the controller is configured to:
perform the driving evaluation by using an evaluation model in which the first data and the second data are input data and the driving evaluation is output data; and
when a causal relationship is found between the surrounding condition and the driving operation performed in the first vehicle, update the evaluation model to increase a value of the driving evaluation to be output for the input data.

9. The information processing device according to claim 1, wherein the first data includes motion data acquired by a sensor mounted on the first vehicle.

10. The information processing device according to claim 1, wherein the second data is image data acquired by a camera mounted on the first vehicle.

11. The information processing device according to claim 10, wherein the controller is configured to make determination about the surrounding condition of the first vehicle based on a result of analyzing the image data.

12. A driving evaluation system comprising:
a first vehicle; and
an information processing device, wherein:
the first vehicle includes a first controller configured to acquire first data related to a driving operation performed in the first vehicle, and second data related to a surrounding condition of the first vehicle; and
the information processing device includes a second controller configured to perform driving evaluation for the first vehicle based on the first data and the second data.

13. The driving evaluation system according to claim 12, wherein the second data is data related to behavior of surrounding traffic for the first vehicle.

14. The driving evaluation system according to claim 12, wherein:
the first controller is configured to periodically transmit the first data and the second data to the information processing device; and
the second controller is configured to perform the driving evaluation based on at least the first data generated in a first period and the second data generated in a second period prior to the first period.

15. The driving evaluation system according to claim 14, wherein the second controller is configured to make determination as to whether the driving operation indicated by the first data is caused by the surrounding condition of the first vehicle that is indicated by the second data.

16. The driving evaluation system according to claim 15, wherein the information processing device further includes a storage configured to store data related to the surrounding condition affecting the driving operation of the first vehicle.

17. The driving evaluation system according to claim 16, wherein the second controller is configured to make the determination by using the stored data.

18. The driving evaluation system according to claim 15, wherein the second controller is configured to correct evaluation of the driving operation performed in the first vehicle when a causal relationship is found between the surrounding condition and the driving operation.

19. The driving evaluation system according to claim 12, wherein the first vehicle further includes a sensor configured to acquire motion data as the first data.

20. The driving evaluation system according to claim 12, wherein the first vehicle further includes a camera configured to acquire image data as the second data.
